(19) United States
(12) Patent Application Publication
(10) Pub. No.: US 2005/0187979 A1
(43) Pub. Date: Aug. 25, 2005

(54) System and method for message-level connection management

(75) Inventors: Erik B. Christensen, Seattle, WA (US); Kenneth D. Wolf, Seattle, WA (US); Michael J. Coulson, Clyde Hill, WA (US); David Wortendyke, Seattle, WA (US); Douglas A. Walter, Issaquah, WA (US); Mike Vernal, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/775,760

(22) Filed: Feb. 9, 2004

(51) Int. Cl. G06F 7/00

(52) U.S. Cl. 707/200

(57) ABSTRACT

A concept for providing a data structure handing process is described. The concept includes determining a size of a data structure, selecting a data streaming protocol when the size exceeds a predetermined limit and selecting a buffered data protocol otherwise.

### TECHNICAL FIELD

This disclosure relates to message-level connection management for electronic data exchange and more particularly to systems and methods for connection management over one or more data channels for electronic data exchange.

### BACKGROUND

As communication devices and technologies have evolved, contact lists have increased in size. The nature of electronic data exchange has increased to encompass more types of multimedia data, with concomitant increase in the amount of data being exchanged on a per-message as well as on per-user or client bases. As a result, message-handling tasks associated with information flow management have also increased in complexity. Further, the variety of types of data channels, each possessing somewhat unique characteristics and limitations, have increased as other aspects of message exchange have become more sophisticated.

The initial ARPA net data exchange typically was limited to brief textual messaging. This information exchange modality was initially developed to facilitate robust data/information exchange, even in light of severe infrastructural damage, such as might be associated with a natural or man-made disaster. Such disasters tend to result in compounded difficulties because they usually also lead to overloading of communications infrastructure. The resultant Internet communication mode is presently capable of handling huge amounts of data with great efficiency and of message exchange when other systems are nonfunctional. Additionally, it is more convenient, in many ways, than some other communications tools, at least in part because the recipient has a greater degree of flexibility in choosing when to read and respond. This is coupled with a high probability of extremely rapid reception by the intended recipient, even when the recipient is many thousands of miles away from the sender, and is often associated with fixed service price (i.e., no incremental per-message costs), color image as well as motion picture and mixed-media messaging transmission capabilities, providing an attractive ensemble of features for many applications. As a result, protocols were developed that presently provide an efficient, often near-real-time communications exchange medium supportive of a broad gamut of multimedia information.

This communications exchange may take place through a series of multiple different kinds of data transmission systems and may employ multiple data transmission paths over at least portions of an operative communications link. Furthermore, the nature of the transmission system may change during a data exchange or from one data exchange to another, resulting in need for routing and handling sophistication as well as flexibility. For example, U.S. Pat. No. 6,671,741 to Dillon, entitled “Apparatus and method for hybrid network access” describes a system in which a personal computer sends messages into a TCP/IP (transfer control protocol/Internet protocol) network using a conventional dial-up link and downloads data from the TCP/IP network using a high-speed one-way satellite link. In this example, a spoofing protocol compensates for long propagation delays inherent to satellite communication; other types of data paths may require different compensatory techniques.

The capabilities provided by such varied yet robust types of data exchange have resulted in increasing application of broadband interconnectivity for heretofore unforeseen applications. For example, it is presently possible to rapidly transmit and/or access medical data such as X-rays, soft tissue images and other complex data structures along with textual or other forms of multimedia information to or from remote locations, facilitating potential for rapid and accurate diagnosis. Such finds application, for example, in treatment recommendations for one or more victims of a vehicular disaster, by one or more doctors who are not co-located with the victims and/or the imaging devices and/or one another and who may be in different cities or countries.

As messaging/handling data content increases, impetus is present to promote larger numbers of data packages being shipped—at least in part because range of applicability is facilitated. Conventional email systems for message/data handling tend to break each such data package into standard-size data elements and then transmit each on a “fire and forget” basis. The received elements then must be collated to provide the data package as transmitted. This process may involve more complex strategies than simple serial concatenation of sequentially-transmitted or sequentially-received records. Framing, or inclusion of so-called header information (or a dataset comprising a set of headers) within each packet, facilitates such combination, with the framing or header information acting in a fashion analogous to the traditional “addressed envelope” familiar with respect to written postal communications.

As a result, in many data handling schema, information is included within each packet to facilitate both common destination targets and later recombination of such packets via a series of “handshakes”, to provide notice that a portion is missing or to provide appropriate assurance regarding integrity level of post-handling data and/or any resultant delivered datagram. Inclusion of such information relies on a common protocol for determination of, and inclusion of, such information. Typical protocols use standard—but optionally variable-length blocks of data (e.g., 32 kilobytes) with a fixed upper bound for block size, and thus, ultimately, for message size.

Additionally, various media/methodologies and adaptations are employed to communicate/handle data packages or datagrams. Many of these related to email are variations on the hyper text transfer protocol (HTTP) approach or the simple mail transfer protocol (SMTP).

However, the present system is known to still present some problems relating to congestion. For example, a long data structure requires more time to be handled than a shorter one, with one potential result being that the data handling system is not available for handling a short data structure while a longer data structure is being handled. This is known as the head-of-line blocking problem.

There are thus increasing needs for methods and apparatus for efficiently routing data structures, which may include larger and more complex electronic data packages than in prior decades, via a gamut of types of data transmission paths.

### SUMMARY

In one aspect, the present disclosure describes a process for providing a data structure handing methodology. The concept includes a process for determining a size of a data structure, selecting a data streaming protocol when the size exceeds a predetermined limit and selecting a buffered data protocol otherwise.

### BRIEF DESCRIPTION

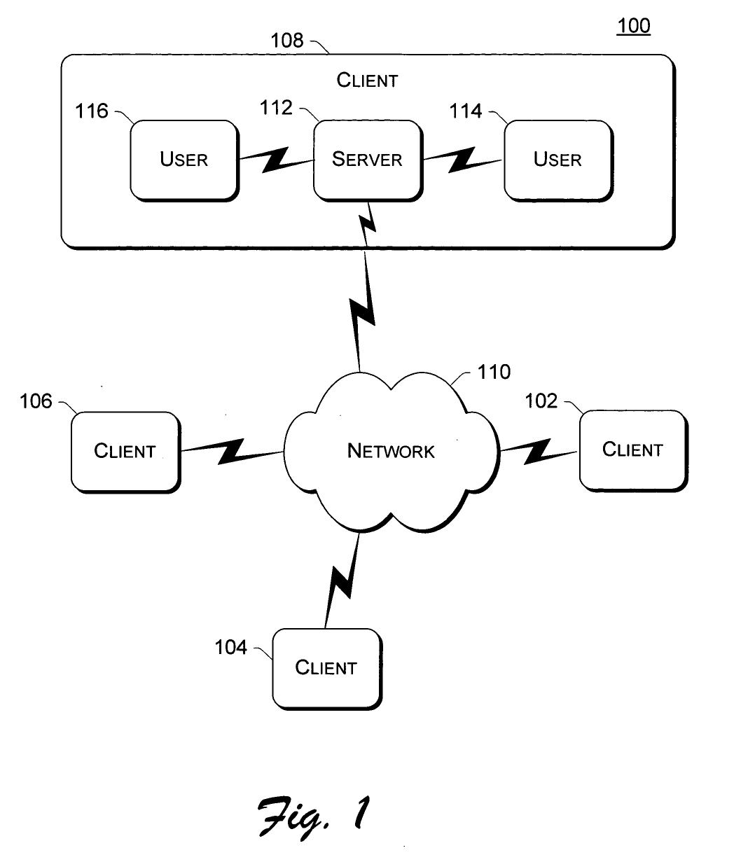

FIG. 1 illustrates an exemplary environment suitable for the concepts of the present disclosure.

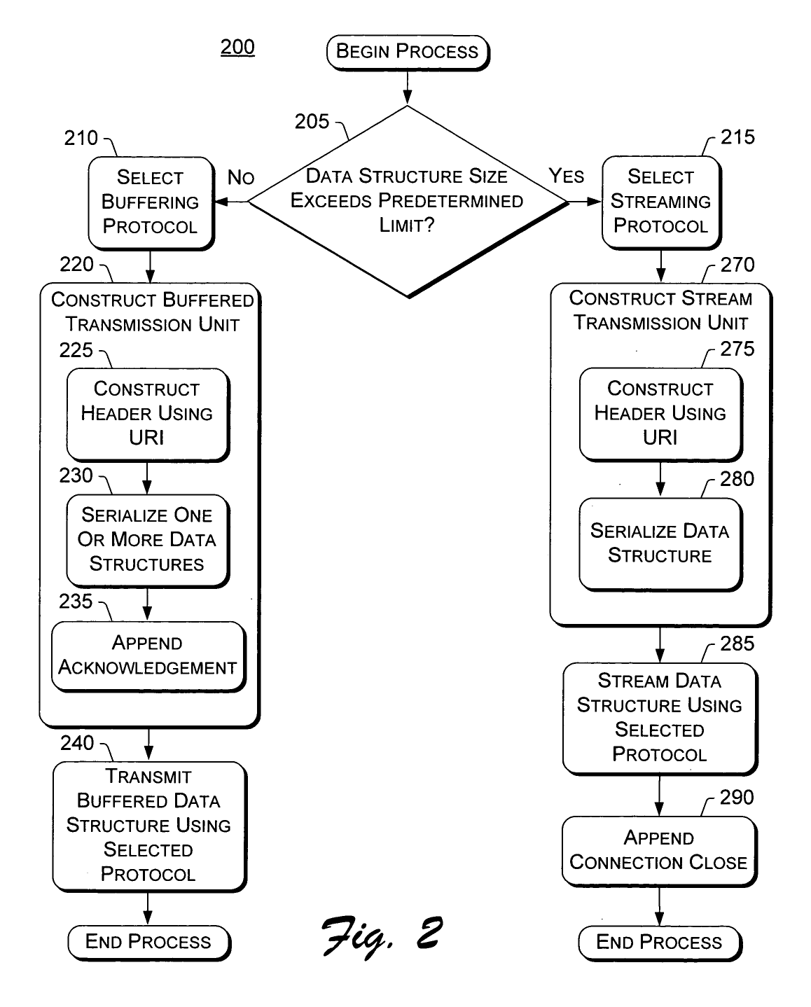

FIG. 2 is a flow chart of a process for determining a suitable transport vehicle for a data structure that finds utility in the environment of FIG. 1.

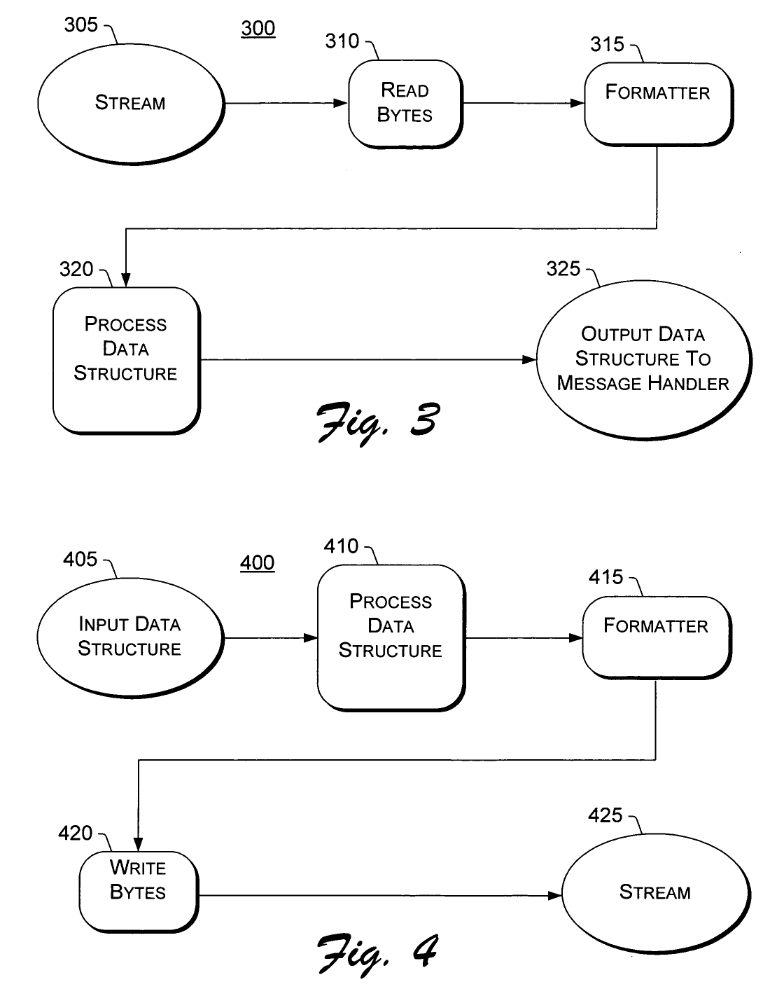

FIG. 3 is a block diagram of a portion of a system for receiving a streamed data structure that finds utility in the environment of FIG. 1.

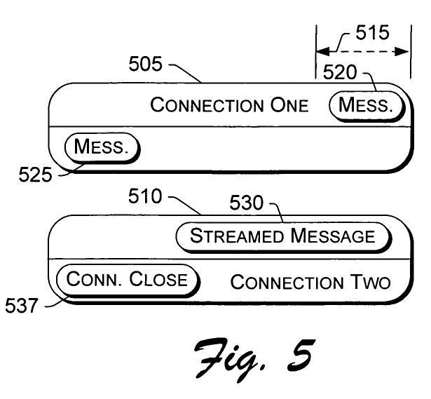

FIG. 4 is a block diagram of a portion of a system for transmitting a streamed data structure that finds utility in the environment of FIG. 1.

FIG. 5 is a block diagram showing buffered and streaming channels that find utility in the environment of FIG. 1.

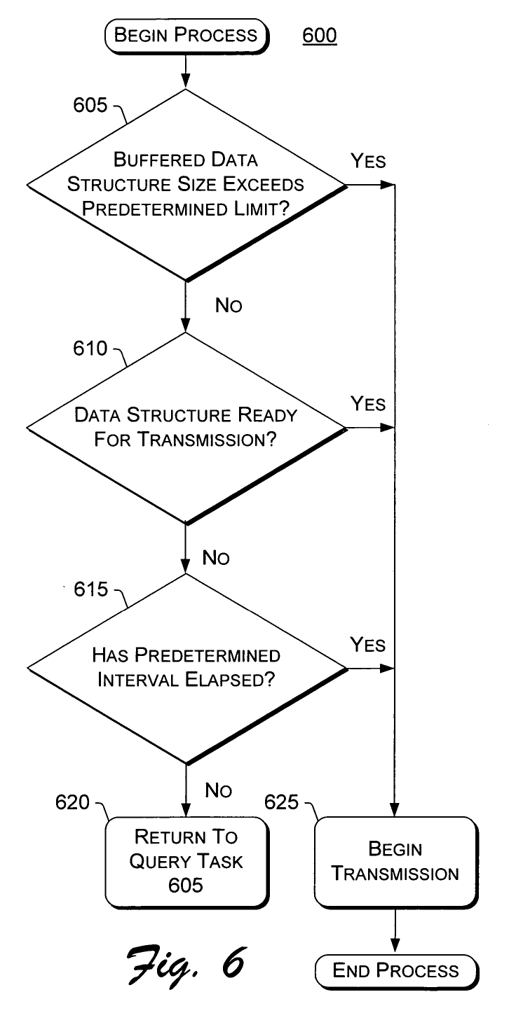

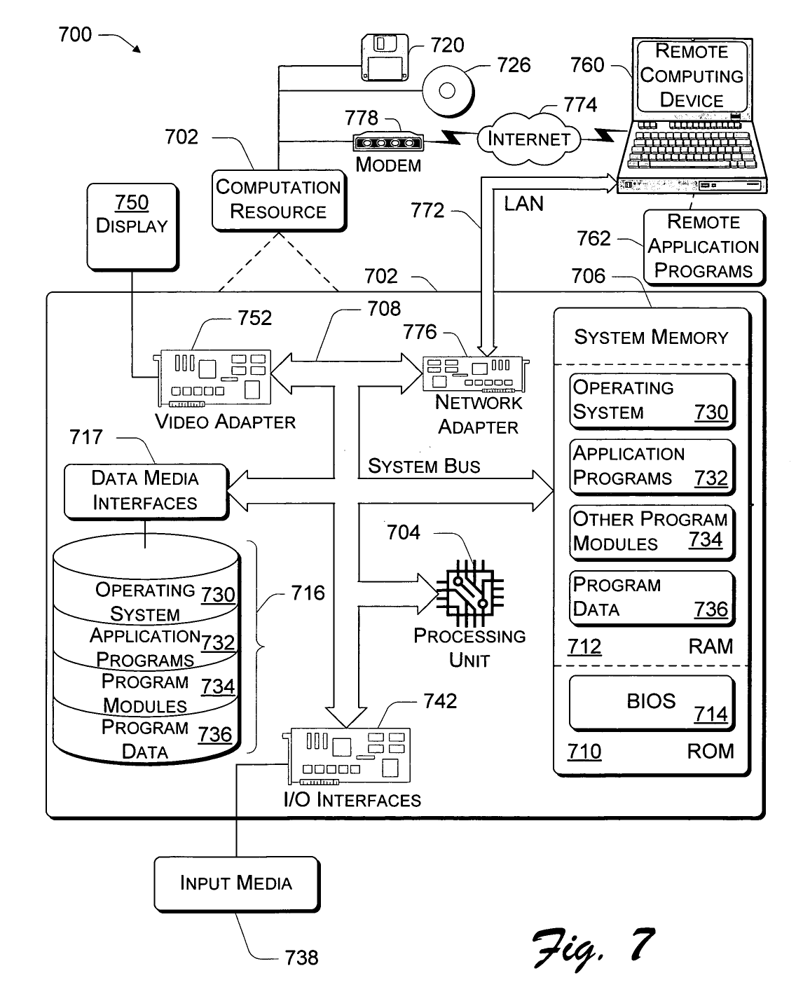

FIG. 6 is a flowchart depicting a process relevant to message handling that finds utility in the environment of FIG. 1.

FIG. 7 is a block diagram of a computer system applicable to the environment of FIG. 1.

### DETAILED DESCRIPTION

The following disclosure describes methods and systems useful in the context of electronic data structure transfer. As used herein, the term “data structure” refers to electronically encoded information that may be exchanged, such as email, data files, electronic images, electronic multimedia content and the like. The disclosure describes addressing and routing using conventional data exchange protocols, and functions in a manner analogous to an envelope and address for routing and delivery of contents using conventional mailing techniques.

As used herein, “transport” or “transport vehicle” is a communication substrate between two or more endpoints and includes radio frequency, digital, wireless, wired and optical transmission media within its scope. Multiple endpoints may correspond to an email with multiple recipients, for example, or may correspond to a multicast communication, which may include multimedia content directed to multiple parties/recipients and which may be intended for contemporaneous information distribution thereto. Logically, a transport creates connections to other endpoints, but connections are a logical construct and are not exposed in the core messaging software. A transport is responsible for serializing the data structure as appropriate, but typically, a transport will only read and write that data framing that is transport-specific and delegates de/serialization of the data structure payload to a formatter. Each formatter encapsulates a data stream underlying each (conceptual) connection.

Introduction

Prior to describing several embodiments illustrating how an improved data structure transfer technology using message-level connection management techniques may be implemented, the following section addresses an exemplary environment in which such technology finds utility. The discussion of the environment provides a framework within which various elements of the improved electronic data and message exchange technology can be developed.

Environment

FIG. 1 illustrates an exemplary environment 100 suitable for implementation of the presently-disclosed concepts. The environment 100 is represented by clients, e.g., clients 102, 104, 106 and 108, interconnected via a network 110, such as the Internet, a LAN, a WAN etc.

Each client may include a server, such as server 112 shown in association with client 108, coupled to users 114, 116. It will be appreciated that while only four clients 102, 104, 106 and 108, one server 112 and two users 114, 116 are depicted for simplicity of illustration and ease of understanding, more or fewer of each may be interconnected.

Typically, interconnections may employ TCP/IP for effectuating data and message routing and communication, and may facilitate connection to remote devices (e.g., web sites, other computer systems and the like) using IP (internet protocol) addresses, URIs (universal resource identifiers) and/or URLs (universal resource locators).

Clients 102-108 may send and receive data and commands using transfer protocols, such as, for example, file transfer protocols (FTP), hyper text transfer protocol (HTTP) or any other protocols known in the art. For example, an HTTP transport can be used to implement SOAP via HTTP and may be used to implement one-way asynchronous communication or two-way synchronous communication.

A variety of transports may be employed with embodiments of the presently-disclosed subject matter. Examples of some transports capable of utility in the disclosed systems are summarized in Table I below.

TABLE I
Examples of transports and
associated transfer protocols.

| Transport | Scheme |
|---|---|
| HttpTransport | http |
| TcpTransport | soap.tcp |
| CrossProcessTransport | ms.soap.xproc |
| InProcessTransport | ms.soap.inproc |
| SmtpTransport | soap.mail |
| Pop3Transport | pop |

Examples of some transports and attendant protocols capable of utility with an embodiment of the disclosed subject matter are summarized in Table II below. The protocols are typically fetched using a command such as “public virtual string Scheme {get;}”, which gets the URI scheme which a given transport supports.

TABLE II
Examples of transports and
associated transfer protocols.

| Transport | Scheme |
|---|---|
| HttpTransport | http |
| TcpTransport | net.tcp |
| CrossProcessTransport | net.ipc |
| InProcessTransport | net.intrAppDomain |
| SmtpTransport | net.mail |
| Pop3Transport | Pop |

However, other protocols may also be employed in conjunction with the subject matter of the present disclosure. A listing of protocols finding utility in the context of the present disclosure is provided below in Table IIIA.

TABLE IIIA
a partial listing of protocols useful with the present disclosure.

| Name | Scheme | Description |
|---|---|---|
| Http Channel | http | Protocol for exchange |
| | | SOAP messages over the |
| | | Internet using HTTP as a |
| | | framing/transfer |
| | | protocol. |
| Tcp Channel | net.tcp | Protocol for exchanging |
| | | SOAP messages over the |
| | | Internet using TCP as the |
| | | transfer protocol. |
| Named Pipes Channel | net.ipc | Protocol for exchanging |
| | | SOAP messages between |
| | | processes on the same |
| | | machine by using named |
| | | pipes. |
| Shared Memory Channel | net.ipc | Protocol for exchanging |
| | | SOAP messages between |
| | | processes on the same |
| | | machine using shared |
| | | memory as a transport. |
| InterAppDomain | net.interAppDomain | Protocol for exchanging |
| Channel | | SOAP messages between |
| | | .NET Framework |
| | | AppDomains in the same |
| | | process. |
| IntraAppDomain | net.intraAppDomain | Protocol for exchanging |
| Channel | | SOAP messages within a |
| | | .NET Framework |
| | | AppDomain. |
| Smtp Channel | net.mail | Protocol for sending |
| | | SOAP messages |
| | | encapsulated within an |
| | | email message using the |
| | | SMTP protocol. |

A continuing list of such protocols is provided below in Table IIIB.

TABLE IIIB
a continuation of the partial listing of protocols of TABLE IIIA.

| Name | Scheme | Description |
|---|---|---|
| pop3 | net.mail | Protocol for receiving |
| | | SOAP messages |
| | | encapsulated within an |
| | | email message using the |
| | | POP3 protocol. |
| imap | net.mail | Protocol for receiving |
| | | SOAP messages |
| | | encapsulated within an |
| | | email message using the |
| | | IMAP protocol. |
| UDP Channel | net.udp | Protocol for exchanging |
| | | SOAP messages |
| | | encapsulated within a |
| | | UDP datagram. |
| File-Based Channel | net.file | Protocol for exchanging |
| | | SOAP messages |
| | | encapsulated within a file |
| | | on a filesystem. |

However, there are needs for increased flexibility and capacity. These needs may be alleviated using message-level connection management, as will be described in more detail below. FIGS. 2-7 and accompanying text describe the disclosed concepts in more detail with reference to the environment addressed above in the context of the environment of FIG. 1.

Process

FIG. 2 is a flow chart of a process 200 for determining a suitable transport vehicle for a data structure that finds utility in the environment 100 of FIG. 1. The process 200 begins in a query task 205.

In the query task 205, the process 200 determines when a size of a data structure exceeds a predetermined limit, which might be, for example, 32 kilobytes or 64 kilobytes, although larger or smaller limits are also useful and the user may have options for setting or re-setting such size limits. When the data structure to be handled exceeds the predetermined size limit, control passes to a block 210. When the data structure to be handled does not exceed the predetermined size limit, control passes to a block 215.

In the block 210, the process 200 selects a buffered data protocol for handling the data structure. For example, the process 200 might select a buffered data protocol from such protocols as HTTP, NET.TCP and NET.IPC. Control then passes to a block 220. In the block 220, the process 200 composes a buffered data transmission unit, which may include more than one message or data structure.

The buffered data transmission unit is constructed by first composing multiple headers that include addressing information and the like in a block 225. The addressing information may be or be derived from a universal resource identifier or URI.

In a block 230, the data structure or structures are serialized. Serialization is the process of taking an instance of a Common Language Runtime object and constructing a representation of that object in octets. Deserialization is the reverse process (the process of taking a set of octets and from that constructing an instance of a CLR object).

Additionally, the process 200 may, in block 235, include an end of data indicator, acknowledgement and/or/message delimiter signal (e.g., analogous to ACK 535, FIG. 5, infra) denoting a terminal end of the serialized buffered data to facilitate system recognition/inference of when a data transmission vehicle is no longer in use as a portion of the task associated with the block 210.

In a block 240, the buffered data structure is transmitted using an appropriate data transfer protocol and path. An exemplary round robin selection of connections from a pool of candidates supported by the process 200 is described below with respect to FIG. 5. The process 200 then ends.

In the block 215, the process 200 selects a data streaming protocol when the size of the data structure exceeds the predetermined limit. For example, the process 200 might select a data streaming protocol from a group comprising: HTTP, NET.TCP, and NET.IPC.

In a block 270, the process 200 constructs a stream transmission unit. In a block 275, the process 200 begins construction of the stream transmission unit by composing a header, which includes addressing information such as may be or be derived from a URI.

In a block 280, the data structure is serialized.

In a block 285, the serialized data structure is streamed, using a data transport vehicle selected in a manner analogous to that as described above with reference to block 240 supra and FIG. 5 infra. For example, first a set of headers, some of which may include addressing information (which may include data such as or extracted from a universal resource identifier) is streamed, the body of the data structure is then streamed and a connection close element (e.g., connection close 537, FIG. 5, in some ways analogous to the acknowledgement 535 associated with buffered messages, block 235) is appended to the data structure and/or is streamed in the block 290. The connection close 537 may be employed within the system to determine or infer when a connection is no longer in use and/or to act as a delimiter between sequentially streamed data structures. The process 200 then ends.

The streaming (block 285) or buffered transmission (block 240) uses a transport. The transport may be accomplished using a transport vehicle for data transmission chosen from a group consisting of: HTTP transport, TCP transport, InterProcess Transport. InterProcess Transport refers to transport of a data structure within a computer; in other words, the source and destination applications may be both hosted on the same device or computer.

System

FIG. 3 is a block diagram of a portion of a subsystem 300 configured for receiving a streamed data structure that finds utility in the environment of FIG. 1. A data stream 305 coming into the subsystem is read as bytes 310 and these are coupled to an input to a formatter 315. The formatter 315 converts between a stream 305 representation of the message and an in-memory, Message instance. FIG. 3 depicts the formatter 315 reading from the incoming stream 305, processing 320 the data structure and outputting data 325 to a message handler (not shown in FIG. 3); this happens when a message is received from another endpoint.

FIG. 4 is a block diagram of a portion of a subsystem 400 configured for transmitting a streamed data structure that finds utility in the environment of FIG. 1. An input data structure 405, such as a SOAP message containing a purchase order is processed 410 and then coupled to an input to a formatter 415. The formatter 415 writes 420 the data structure as bytes into a data stream 425, which is then transmitted.

FIG. 5 is a block diagram showing first 505 and second 510 connections that find utility in the environment of FIG. 1. The first 505 and second 510 connections allow bidirectional information flow. A horizontal line shown in each separates data travelling to the right (shown above each line) and data travelling to the left (shown below each line).

In FIG. 5, the first connection 505 represents a buffered data connection, with an associated buffer size as indicated by bidirectional arrow 515. A buffered message MESS. 520 having a size smaller than the buffer size is being transferred to the right, and another buffered message MESS. 525 is being transferred to the left.

In FIG. 5, the second connection 510 represents a streaming data connection which may be used to stream a data structure of arbitrarily large size within system determined constraints. For example, a system limit of two gigabytes might be set as an upper size for a streamed data structure. A streamed data structure 530 is being transferred to the right. A connection close Conn. Close 537 is being streamed to the left.

Streaming is not efficient for handling small data structures. Additionally, buffering concatenations of small data structures may only increase latency when the transport connections are relatively empty.

An adaptive approach can provide throughput improvement and also obviate the “head-of-line” blocking issue. Maintaining two pools of multiple connections, each such as one of connections 505 and 510 of FIG. 5, for each endpoint allows selection. That is, by having one pool or set of at least one connection for streaming (dedicated) connections, and one pool for buffered data connections, a connection may be selected within the appropriate pool (e.g., using a process such as process 200 of FIG. 2) in accordance with characteristics of the data structure. In one embodiment, a single connection is used once for each large streaming data structure and then is “torn down”, i.e., closed.

When a data structure/message is sent, it will eventually reach an internal connection manager. That connection manager will attempt to find a free connection to the message destination. Using round-robin selection, if a free connection exists in the appropriate pool, it will use that one. Otherwise, it will create a new connection (up to a configurable limit) and use that to transmit the message.

Round robin selection simply means that of a pool of, for example, four known connections, a first predetermined is selected if it is available, and if not, a predetermined second one is then considered. In other words, they are sequentially polled in order for sequential data structure handling tasks, if available, using a predetermined regime. Alternative selection schemes include random selection (e.g., just randomly choosing a connection from the pool), choosing a connection in order of priority based on a network attribute (such as bandwidth, noise characteristics, knowledge of the connections and nature of the data structure, e.g., text only poses different bandwidth requirements than images or video) and “pick and stick” where a first message picks a connection modality using, e.g., random selection or any other selection approach, and the rest of the contemporaneous messages along that channel use that same connection until it is closed/torn down.

This system differs from prior electronic messaging systems in that the granularity at the data structure handling level comprises individual messages/data structures, rather than predetermined data packet sizes such as bytes.

Message-Level Nagling

FIG. 6 is a flowchart depicting a process 600 relevant to message handling that finds utility in the environment of FIG. 1 with respect to buffered and streamed data structures. The process 600 begins in a query task 605.

In the query task 605, the process 600 determines when a buffered data structure representing one or more messages exceeds a predetermined size limit and thus that the process 600 is ready for transmission of the buffered data structure to begin. For example, the query task 605 determines when the buffered data structure size reaches a predetermined default value, such as 32 kilobytes, which predetermined value may be adjustable or reconfigurable by a system administrator, an individual user and/or via an update from a supplier of message-level connection management tools. When the query task 605 determines that the buffered data structure does not exceed the predetermined size limit, control passes to a query task 610.

In the query task 610, the process 600 determines when a buffered data structure is ready for transmission and thus that the process 600 is ready for transmission of the buffered data structure to begin. For example, when the buffered data structure represents an entire message, and available system resources exceed predetermined values, the buffered data structure is ready for transmission. Further buffering in this scenario simply increases latency with no particular system benefit, as described above with reference to FIG. 5. When the query task 610 determines that the data structure is not yet ready for transmission, control passes to a query task 615.

In the query task 615, the process 600 determines when a predetermined interval has elapsed since initialization of data structure transmission and thus that the process 600 is ready for transmission of the buffered data structure to begin. For example, the query task 615 may determine that such as 200 milliseconds has elapsed since initialization of data structure transmission. The predetermined interval size may be adjustable or reconfigurable by a system administrator, an individual user and/or via an update from a supplier of message-level connection management tools.

When the query task 615 determines that the predetermined interval has not yet elapsed, control passes to a block 620 to return the process 600 to the query task 605. The process 600 thus iterates until one of the criteria of the query tasks 605, 610 or 615 is satisfied, indicating that the process 600 is ready to initiate transmission of the buffered data structure. When any of the query tasks 605, 610 or 615 indicates the process 600 is ready for transmission of the buffered data structure to begin, control passes to a block 625.

In the block 625, the process 600 initiates transmission of the buffered data structure. The process 600 then ends.

The process 600 provides several benefits in the context of message-level connection management. A first benefit flows from knowledge that it is more efficient to infrequently pass relatively large buffered data structures to networking application program interfaces than it is to frequently pass relatively small buffered data structures. This is because it allows underlying network resources to more efficiently handle the data structures.

A second benefit flows from knowledge that a default policy of at least those message-level connection management systems conforming with the disclosed concepts is to buffer a first portion, such as a first 32 kilobytes of the data structure, and to stream a second portion such as a remainder of the data structure. As a result, the system time spent filling buffers such as those on the receiver side is reduced. In other words, by waiting until it can be determined that the receiver buffer will be filled by the data structure being handled, and then sending the data structure, the overall amount of system time that is spent filling various buffers such as receiver buffers is reduced. The receiver may also express to the system or sender, for example via policy, a receive buffer size, and a Nagle size associated with handling the data structure can be adapted in conformance with such.

Computer System

FIG. 7 illustrates an example of a general computer environment 700 applicable to the context of the system 200 of FIG. 2. The illustrated operating environment is only one example of a suitable operating environment and is not intended to suggest any limitation as to the scope of use or functionality of the embodiments of this disclosure. Other well-known computing systems, environments, and/or configurations may be suitable for implementation of the disclosure.

The present disclosure is provided in part in the general context of computer-executable instructions, such as program modules, executed by one or more computers or other devices. Generally, program modules include routines, programs, objects, components, data structures etc. that perform particular tasks or implement particular abstract data types. Typically the functionality of the program modules may be combined or distributed as desired in various embodiments.

The concepts disclosed herein may be implemented in hardware or a combination of hardware, software, and/or firmware. For example, one or more application specific integrated circuits (ASICs) could be designed or programmed to embody the concepts disclosed herein.

FIG. 7 depicts a general example of a computation resource 702 that can be used to implement the processes described herein. The computation resource 702 is shown as an example of a computer in which various embodiments of these processes can be practiced. The computation resource 702 is illustrated as only an example of a computing device that may be used with the invention; other devices may alternatively used that include more components or alternatively fewer components than those illustrated in FIG. 7.

The computation resource 702 includes one or more processors or processing units 704, a system memory 706, and a bus 708 that couples various system components including the system memory 706 to processor(s) 704. The bus 708 represents one or more of any of several types of bus structures, including a memory bus or memory controller, a peripheral bus, an accelerated graphics port and a processor or local bus using any of a variety of bus architectures. The system memory 706 includes nonvolatile read only memory (ROM) 710 and random access memory (RAM) 712, which may or may not be a volatile memory. A basic input/output system (BIOS) 714, containing the basic routines that help to transfer information between elements within computation resource 702, such as during start-up, is stored in ROM 710.

The computation resource 702 further may include a hard disk drive 716 for reading from and writing to a hard disk, not shown, coupled to bus 708 via a data media interface 717 (e.g., a SCSI, ATA, or other type of interface); a magnetic disk drive (not shown) for reading from and writing to a removable magnetic disk 720 and an optical disk drive (not shown) for reading from and/or writing to a removable optical disk 726 such as a compact disc or CD, DVD, or other optical media. The hard disk drive 716, magnetic disk drive and/or optical disk drive are each coupled to the system bus 708 by one or more data media interfaces 717.

The drives and their associated computer-readable media provide nonvolatile storage of computer readable instructions, data structures, program modules and other data for the computation resource 702.

Although the exemplary environment is described herein as employing a hard disk drive 716, a removable magnetic disk 720 and a removable optical disk 726, it will be appreciated by those skilled in the art that other types of computer readable media which can store data that is accessible by a computer, such as magnetic cassettes, flash memory cards, random access memories (RAMs), read only memories (ROM), and the like, may also be used in the exemplary operating environment.

A number of program modules may be stored on the hard disk drive 716, magnetic disk 720, optical disk 726, ROM 710, or RAM 712, including an operating system 730, one or more application programs 732, other program modules 734 and program data 736. A user may enter commands and information into computation resource 702 through input devices such as input media 738 (e.g., keyboard/keypad, tactile input or pointing device, joystick, touchscreen or touchpad, microphone, antenna etc.). Such input devices 738 are coupled to the processing unit 704 through an input/output interface 742 that is coupled to the system bus (e.g., a serial port interface, a parallel port interface, a universal serial bus (USB) interface, an IEEE 1354 (Firewire) interface, etc.). A monitor 750 or other type of display device is also coupled to the system bus 708 via an interface, such as a video adapter 752.

The computation resource 702 may include capability for operating in a networked environment using logical connections to one or more remote computers, such as a remote computer 760. The remote computer 760 may be a personal computer, a server, a router, a network PC, a peer device or other common network node, and typically includes many or all of the elements described above relative to the computation resource 702. In a networked environment, such as that illustrated with computing environment 700, program modules depicted relative to the computation resource 702, or portions thereof, may be stored in a remote memory storage device. By way of example, remote application programs 762 reside on a memory device of the remote computer 760. The logical connections represented in FIG. 7 may include a local area network (LAN) 772 and/or a wide area network (WAN) 774.

Such networking environments are commonplace in modern computer networks, and in association with intranets and the Internet. In certain embodiments, the computation resource 702 executes an Internet Web browser program (which may optionally be integrated into the operating system 730) such as the “Internet Explorer” Web browser manufactured and distributed by Microsoft Corporation of Redmond, Wash.

When used in a LAN networking environment, the computation resource 702 is coupled to a network such as the local area network 772 through a network interface or adapter 776. When used in a WAN networking environment, the computation resource 702 typically includes interfaces such as a modem 778, such as a broad band or cable modem, or other means for establishing communications over the wide area network 774, such as the Internet. The modem 778, which may be internal or external, is typically coupled to the system bus 708 via a serial port interface. In a networked environment, program modules depicted relative to the computation resource 702, or portions thereof, may be stored in the remote memory storage device. It will be appreciated that the network connections shown are exemplary and other means of establishing a communications link between the computers may be used.

The computation resource 702 typically includes at least some form of computer readable media. Computer readable media can be any available media that can be accessed by the computation resource 702. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD, digital versatile disks (DVD) or other optical storage, magnetic cassettes, magnetic tape, magnetic disk storage or other magnetic storage devices, or any other media which can be used to store the desired information and which can be accessed by the computation resource 702.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

By way of example, and not limitation, communication media includes wired media such as wired network or direct-wired connection, and wireless media such as acoustic, RF, infrared and other wireless media. Combinations of any of the above should also be included within the scope of computer readable media.

### CONCLUSION

Although the description above uses language that is specific to structural features, data organizational and/or storage schemata and/or methodological acts, it is to be understood that the recitation of the appended claims is not limited to the specific features or acts described. For example, it will be appreciated that the data handling concepts described herein are not limited to any specific data transmission protocol, rather, these data handling concepts may be implemented within a broad range of message/content exchange techniques. It will be appreciated that the specific features and acts are disclosed as exemplary forms of implementing these concepts.

1. A data structure handing process comprising:
determining a size of a data structure;
selecting a data streaming protocol when the size exceeds a predetermined limit;
selecting a buffered data protocol otherwise.

2. The process of claim 1, selecting a buffered data protocol further comprising serializing one or more data structures into a data transmission unit terminating with a delimiting code.

3. The process of claim 1, selecting a buffered data protocol further comprising including an end of data indicator for denoting when a data transmission vehicle is no longer in use.

4. The process of claim 1, selecting a data streaming protocol further comprising streaming the data structure by:
streaming a header;
streaming the data structure;
streaming an acknowledge code.

5. The process of claim 1, selecting a data streaming protocol further comprising streaming the data structure by buffering a first portion of the data structure and streaming a second portion of the data structure.

6. The process of claim 1, further comprising selecting a data transmission vehicle from a pool of available data transmission vehicles.

7. The process of claim 1, further comprising selecting a data transmission connection from a pool of available data transmission connections using round robin selection.

8. The process of claim 1, further comprising formatting the data structure in accordance with at least one protocol chosen from a group consisting of: simple mail transfer protocol, POP3, hyper text transfer protocol, file transfer protocol and transfer control protocol/Internet protocol.

9. The process of claim 1, further comprising using a transport vehicle for data transmission chosen from a group consisting of: HTTP transport, TCP transport, InterProcess Transport, InProcess Transport, SMTP transport and POP3 Transport.

10. The process of claim 1, further comprising selecting a transmission scheme chosen from a group consisting of: HTTP, SOAP.TCP, NET.TCP, MS.SOAP.XPROC, NET.IPC, MS.SOAP.INPROC, NET.INAPPDOMAIN, SOAP.MAIL, NET.MAIL and POP.

11. A system for handling messages comprising:
means for determining a size of a data structure;
means for selecting a data streaming protocol when the size exceeds a predetermined limit;
means for selecting a buffered data protocol when the size does not exceed the predetermined limit.

12. The system of claim 11, the determining means further comparing the size to the predetermined limit.

13. The system of claim 11, further comprising:
means for prefacing the data structure with addressing information;
means for denoting an end-of-message.

14. The system of claim 11, further comprising means for exchanging information expressive of buffer size.

15. The system of claim 11, further comprising:
means for buffering a first portion of the data structure;
means for streaming a second portion of the data structure.

16. A computer readable storage medium having encoded thereon computer readable code, that, when executed by one or more processors, is configured to cause one or more processors to select a data handling vehicle based on determining availability of such chosen from a predetermined pool of data handling vehicles.

17. The computer readable storage medium of claim 16, the computer readable code configured to cause the one or more processors to select comprising computer readable code configured to cause the one or more processors to select from amongst a pool of streaming connections and a pool of buffered connections.

18. The computer readable storage medium of claim 16, the computer readable code configured to cause the one or more processors to select comprising computer readable code configured to cause the one or more processors to select between a streaming data handling capability and a buffering data handling capability based on a size of a data structure to be handled.

19. The computer readable storage medium of claim 16, the computer readable code configured to cause the one or more processors to select comprising computer readable code configured to cause the one or more processors to select a connection from the pool using round robin selection, and, when the pool is determined to be void of unused connections, create a connection.

20. The computer readable storage medium of claim 16, the computer readable code being further configured to cause the one or more processors to:
determine a size of a data structure to be handled;
compare the size to a predetermined threshold value;
base a choice of data handling modalities on the size and threshold value.

21. The computer readable storage medium of claim 16, the computer readable code being further configured to cause the one or more processors to:
first determine when a size of a buffered data structure exceeds a predetermined limit, and, when so, begin transmission of the buffered data structure, and, alternatively;
second determine when the buffered data structure is ready for transmission, and, when so, begin transmission of the buffered data structure, and, alternatively;
third determine when a predetermined temporal interval has passed beginning with initiation of buffering of the buffered data structure, and, when so, begin transmission of the buffered data structure;
iterate first, second and/or third determinations until transmission of the buffered data structure is initiated.

22. An apparatus comprising a computer-based product that is configured to:
first determine when a size of a buffered data structure exceeds a predetermined limit, and, when so, begin transmission of the buffered data structure, and, alternatively;
second determine when the buffered data structure is ready for transmission, and, when so, begin transmission of the buffered data structure, and, alternatively;
third determine when a predetermined temporal interval has passed beginning with initiation of buffering of the buffered data structure, and, when so, begin transmission of the buffered data structure;
iterate first, second and/or third determinations until transmission of the buffered data structure is initiated.

23. The apparatus of claim 22, the computer-based product being configured to:
select a transport from among a pool of transports;
initiate transmission of the buffered data structure using the selected transport.

24. The apparatus of claim 22, the computer-based product being configured to:
select a transport from among a pool of transports including InProcess, CrossProcess, HTTP, SMTP, TCP and POP3;
initiate transmission of the buffered data structure using the selected transport.
